(19) United States
(12) Patent Application Publication
(10) Pub. No.: US 2026/0322582 A1
(43) Pub. Date: Oct. 15, 2026

(54) Homomorphic Encryption Abstraction Layer (HEAL)

(71) Applicant: LatticaAI, Inc., Dover, DE (US)

(72) Inventor: Rotem Tsabary, Tel Aviv (IL)

(21) Appl. No.: 19/459,017

(22) Filed: Jan. 26, 2026

Related U.S. Application Data
(60) Provisional application No. 63/752,866, filed on Feb. 3, 2025.

(51) Int. Cl. H04L 9/00

(52) U.S. Cl. CPC H04L 9/008

(57) ABSTRACT

An apparatus for performing Fully Homomorphic Encryption (FHE) computations includes an accelerator interface and a processor. The accelerator interface is configured to communicate with a hardware accelerator. The processor is configured to receive or generate an accelerator-agnostic workflow that includes one or more FHE computations, compile the accelerator-agnostic workflow into a transcript of operations drawn from a predefined set of operations in which (i) data is represented using tensors and (ii) at least some of the operations are represented as parallelized computations over dimensions of the tensors, and send the transcript for execution on the hardware accelerator.

### CROSS-REFERENCE TO RELATED APPLICATIONS

This application claims the benefit of U.S. Provisional Patent Application 63/752,866, filed Feb. 3, 2025, whose disclosure is incorporated herein by reference.

### FIELD OF THE INVENTION

The present invention relates generally to homomorphic encryption, and particularly to methods and systems for accelerating homomorphic encryption operations.

### BACKGROUND OF THE INVENTION

Homomorphic encryption allows computations to be performed on encrypted data without decryption, enabling secure processing in untrusted environments such as cloud computing platforms. In spite of the strong security and privacy guarantees they provide, the practical deployment of homomorphic encryption schemes has been limited by computational complexity and performance challenges.

Modern hardware accelerators, including graphics processing units (GPUs), Field-Programmable Gate Arrays (FPGAs) and Application-Specific Integrated Circuits (ASICs), offer significant potential for improving homomorphic encryption performance through parallel processing capabilities. To date, however, no solution exists for accelerating homomorphic encryption computations in a manner that efficiently exploits the capabilities of hardware accelerators.

### SUMMARY OF THE INVENTION

An embodiment of the present invention that is described herein provides an apparatus for performing Fully Homomorphic Encryption (FHE) computations. The apparatus includes an accelerator interface and a processor. The accelerator interface is configured to communicate with a hardware accelerator. The processor is configured to receive or generate an accelerator-agnostic workflow that includes one or more FHE computations, compile the accelerator-agnostic workflow into a transcript of operations drawn from a predefined set of operations in which (i) data is represented using tensors and (ii) at least some of the operations are represented as parallelized computations over dimensions of the tensors, and send the transcript for execution on the hardware accelerator.

In some embodiments, compilation of the accelerator-agnostic workflow, and the transcript produced by the compilation, are specific to a type of the accelerator.

In some embodiments, at least some of the operations in the set represent data as polynomials represented in a double Chinese Remainder Theorem (CRT) format, and represent the polynomials using respective tensors. In an example embodiment, one or more of the operations in the set include an operation between tensors that represent the polynomials. In a disclosed embodiment, one or more of the operations in the set include an operation between a tensor representing a polynomial and a constant. In an embodiment, the set of operations includes an operation that applies a Number Theoretic Transform (NTT) or an inverse NTT to a polynomial represented as a tensor.

In an example embodiment, the set of operations includes one or both of (i) an operation that permutes coefficients of a vector, and (ii) an operation that reshapes a tensor.

In some embodiments, in compiling the accelerator-agnostic workflow, the CPU is configured to use one or more predefined composite FHE operations, a given composite FHE operation made up of two or more of the operations in the set. In an example embodiment, the composite FHE operations include one or more of (i) an operation that decomposes a polynomial into a digit-based representation, (ii) an operation that converts ciphertext from a first encryption key to a second encryption key (iii) an operation that performs bootstrapping, and (iv) an operation that converts a representation of a polynomial from a first modulus to a second modulus.

There is additionally provided, in accordance with an embodiment of the present invention, a method for performing Fully Homomorphic Encryption (FHE) computations. The method includes receiving an accelerator-agnostic workflow that includes one or more FHE computations. The accelerator-agnostic workflow is compiled into a transcript of operations drawn from a predefined set of operations in which (i) data is represented using tensors and (ii) at least some of the operations are represented as parallelized computations over dimensions of the tensors. The transcript is sent for execution on a hardware accelerator.

There is also provided, in accordance with an embodiment of the present invention, a computer software product, the product including a tangible non-transitory computer-readable medium in which program instructions are stored. The instructions, when read by one or more processors, cause the one or more processors to receive or generate an accelerator-agnostic workflow that includes one or more Fully Homomorphic Encryption (FHE) computations, to compile the accelerator-agnostic workflow into a transcript of operations drawn from a predefined set of operations in which (i) data is represented using tensors and (ii) at least some of the operations are represented as parallelized computations over dimensions of the tensors, and to send the transcript for execution on a hardware accelerator.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for performing Fully Homomorphic Encryption (FHE) computations, in accordance with an embodiment of the present invention;

FIG. 2 is a flow chart that schematically illustrates a method for performing FHE computations, in accordance with an embodiment of the present invention; and

FIG. 3 is a diagram that schematically illustrates an example of accelerating an FHE computation, in accordance with an embodiment of the present invention.

### DETAILED DESCRIPTION OF EMBODIMENTS

### Overview

Fully Homomorphic Encryption (FHE) enables computations to be performed directly on encrypted data without requiring decryption, offering transformative potential for secure cloud computing, privacy-preserving machine learning, and confidential data processing in general. However, despite its theoretical promise, FHE has seen limited practical adoption due to severe performance limitations and implementation complexity.

FHE operations are computationally intensive, requiring complex polynomial arithmetic, modular operations, and number theoretic transforms that can be orders of magnitude slower than operations on unencrypted data. While hardware accelerators offer the potential to dramatically improve FHE performance by exploiting parallelism inherent in cryptographic operations, existing FHE implementations fail to effectively leverage these capabilities.

Current approaches tightly couple algorithmic FHE implementations to specific hardware platforms, creating rigid dependencies that limit portability and flexibility. FHE computations have distinct computational characteristics and optimization requirements, further complicating hardware integration. Additionally, data representation and memory management in FHE operations introduce substantial overhead, with existing systems often requiring extensive data reformatting between operations that can negate potential performance gains from hardware acceleration.

Embodiments of the present invention that are described herein address these challenges by using a Homomorphic Encryption Abstraction Layer (HEAL) specifically designed for FHE workloads. In U.S. Provisional Patent Application 63/752,866, cited above, HEAL is referred to as Hardware Abstraction Layer (HAL). The two terms are used interchangeably herein.

The disclosed HEAL is based on a predefined set of core operations, expressed as tensor-based data operations that naturally align with the parallel processing capabilities of modern hardware accelerators. The core operations in the set include the fundamental computational primitives common in FHE. Typically, a multi-dimensional tensor corresponds to a polynomial represented in double Chinese Remainder Theorem (CRT) format, along with additional dimensions for ciphertext components, batching, rotations and more.

In various embodiments the core operations in the set may include, for example, modular arithmetic operations such as addition and multiplication, Number Theoretic Transform (NTT) and inverse NTT operations for efficient polynomial multiplication, coefficient permutation operations, tensor reshaping operations and explicit memory management functions for efficient data transfer between CPU and hardware accelerators.

In addition, the HEAL typically uses a set of high-level FHE operations, also referred to as composite operations. A high-level FHE operation typically comprises a sequence of two or more core operations. Examples of high-level operations include, but are not limited to, gadget decomposition operations, key-switching operations, modulus switching operations and bootstrapping operations.

In a typical flow, the HEAL receives or generates an accelerator-agnostic workflow comprising FHE computations. In the present context, the term “accelerator-agnostic” means that the workflow is specified at a relatively high level, and is not tailored to the architecture, constraints or requirements of a specific hardware accelerator. The accelerator-agnostic workflow is also referred to as an FHE application workflow.

The HEAL typically comprises a compiler and a runtime component. The compiler compiles (“lowers”) the accelerator-agnostic workflow into an execution transcript, also referred to as simply “transcript” for brevity. In the present context, the term “transcript” refers to an ordered representation of operations drawn from the predefined set of core operations and composite operations. The core operations, and the transcript as a whole, are tailored to the specific accelerator being used.

The HEAL runtime component is the component that interfaces with the hardware accelerator. The runtime component orchestrates the execution of the transcript by the accelerator, typically including tasks such as memory management, operation dispatching and sequencing.

By defining a minimal yet highly expressive set of core operations, the disclosed HEAL facilitates the implementation of complex FHE algorithms while maintaining hardware independence. By decoupling FHE algorithm implementations from hardware-specific details, the HEAL enables the same algorithmic workflow to execute efficiently across diverse hardware platforms without modification.

The decoupling provided by the disclosed HEAL allows FHE algorithm developers to focus on algorithmic innovation without requiring deep hardware expertise. At the same time, hardware-level software developers are able to optimize implementations for specific platforms without affecting the implementation and optimization of higher-level algorithms. The result is accelerated development, improved portability, and independent optimization of algorithms and accelerator-level software implementations, ultimately making practical FHE deployments more feasible across diverse application domains.

### System Description

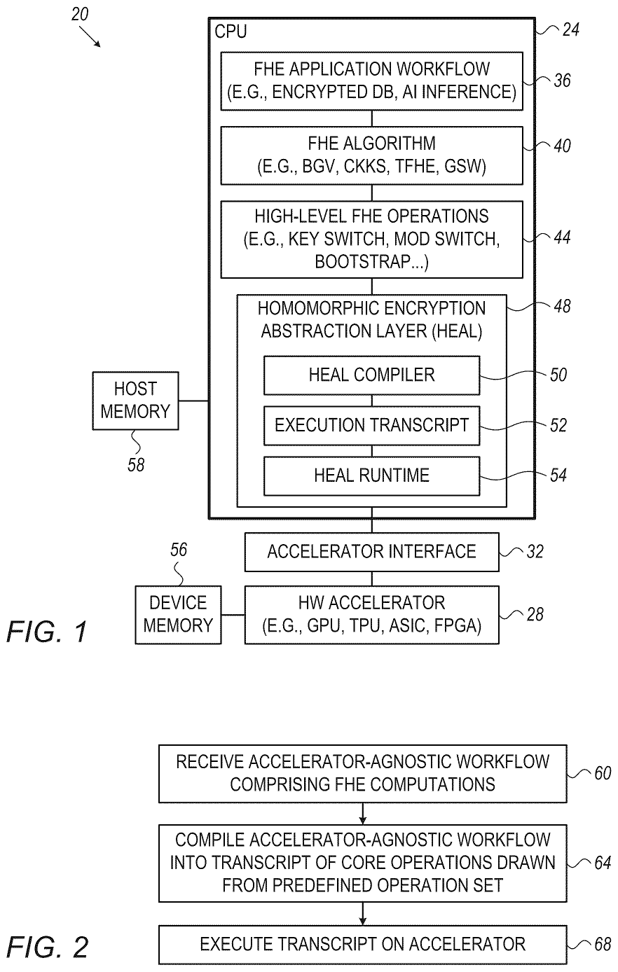

FIG. 1 is a block diagram that schematically illustrates a system 20 for performing Fully Homomorphic Encryption (FHE) computations, in accordance with an embodiment of the present invention. System 20 comprises a processor, in the present example a CPU 24, and a hardware accelerator 28, which may comprise a GPU, a Tensor Processing Unit (TPU), an FPGA, an ASIC, or any other suitable hardware accelerator. Accelerator 28 accelerates the execution of FHE computations for CPU 24. CPU 24 communicates with accelerator 28 through an accelerator interface 32 that facilitates data transfer and instruction execution between the processor and accelerator.

The architecture within CPU 24 includes multiple software layers that provide abstraction and modularity for FHE operations. At the application level, an FHE application 36 workflow specifies encrypted computations such as privacy-preserving machine learning inference, secure database queries, or confidential data analytics. Below the application layer, an FHE algorithm 40 implements specific FHE schemes such as Brakerski-Gentry-Vaikuntainen (BGV), Cheon-Kim-Kim-Song (CKKS), Torus Fully Homomorphic Encryption (TFHE), or Gentry-Sahai-Waters (GSW), each with distinct computational characteristics and optimization requirements.

In the present example, at least some of the building blocks of FHE algorithm 40 comprise high-level FHE operations 44, also referred to as composite operations. A given high-level FHE operation 44 comprises an ordered sequence of operations drawn from a predefined set of core operations. The core operations are fundamental computational primitives optimized for parallel computation. As noted above, the core operations may comprise, for example, modular arithmetic operations, NTT and inverse NTT operations, coefficient permutation operations, tensor reshaping operations and explicit memory management functions. High-level FHE operations may comprise, for example, gadget decomposition, key-switching, modulus switching and bootstrapping.

A Homomorphic Encryption Abstraction Layer (HEAL) 48 serves as a critical intermediary between FHE application workflow 36 and the underlying hardware infrastructure of accelerator 28. HEAL 48 receives the accelerator-agnostic FHE application workflow 36, and compiles this workflow into a transcript of operations drawn from the FHE core operations and/or composite operations 44, as specified by the specifications of accelerator interface 32. In the present example, HEAL 48 comprises a compiler 50 that compiles FHE application workflow 36 into an execution transcript 52, and a runtime component 54 that orchestrates the execution of transcript 52 on accelerator 28.

Typically, to compile an accelerator-agnostic workflow into a transcript that will be executed on a given accelerator, compiler 50 of HEAL 48 uses a set of core operations and composite operations specified for that accelerator.

Accelerator interface 32 manages the communication between CPU 24 and hardware accelerator 28. The interface sends core operations, which were dispatched by runtime component 54 of HEAL 48, to hardware accelerator 28 for execution. Interface 32 also handles data transfer between CPU 24 and accelerator 28.

In the present example, system 20 further comprises a host memory 58 coupled to CPU 24, and a device memory 56 coupled to accelerator 28. Some of the core operations in HEAL 48 allocate memory regions in device memory 56 for storing various tensors, transfer data efficiently between memories 56 and 58, and align data in device memory 56 in a manner that simplifies access and processing by accelerator 28.

The configuration of system 20, as illustrated in FIG. 1, is an example configuration that is chosen purely for the sake of conceptual clarity. In alternative embodiments, any other suitable configuration can be used. In various embodiments, the various elements of system 20 may be implemented using suitable hardware, such as in one or more ASICs or FPGAs, using software, or using a combination of hardware and software elements. Elements that are not mandatory for understanding of the disclosed techniques have been omitted from the figure for the sake of clarity.

In some embodiments, CPU 24 and/or accelerator 28 may be implemented using one or more general-purpose processors that are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

FIG. 2 is a flow chart that schematically illustrates a method for performing FHE computations, in accordance with an embodiment of the present invention. The method demonstrates the transformation of a high-level FHE workflow into optimized hardware-executable operations by HEAL 48.

The method begins at a workflow input stage 60, in which CPU 24 receives or generates an accelerator-agnostic workflow (e.g., workflow 36 of FIG. 1) comprising one or more FHE computations. In the present example the accelerator-agnostic workflow is generated for an FHE application using FHE algorithm 40. In alternative embodiments, HEAL 48 may receive the accelerator-agnostic workflow from an external source, e.g., from an FHE application running on another processor.

At a compilation stage 64, compiler 50 of HEAL 48 compiles the accelerator-agnostic workflow (e.g., workflow 36) into execution transcript 52, comprising operations drawn from the set of core operations. When appropriate, compiler 50 may use high-level FHE operations 44 for implementing portions of the workflow, instead of individual core operations. In either case, the end result is an execution transcript comprising operations supported by hardware accelerator 28 as specified by accelerator interface 32.

Following compilation, at an execution stage 68, runtime component 54 of HEAL 48 orchestrates the execution of transcript 52 on accelerator 28. Runtime component 54 typically schedules and dispatches core operations from transcript 52, and sends the core operations through accelerator interface 32 for execution on hardware accelerator 28. Hardware accelerator 28 executes the core operations as specified in the transcript.

Since the transcript is optimized for the specific accelerator, execution of the transcript on accelerator 28 is highly efficient in exploiting the accelerator's parallel processing capabilities. The resulting execution is thus fast and efficient.

### Key Heal Features

In some embodiments, the set of core operations and composite operations, and their compilation by HEAL 48, incorporate several key features that facilitate efficient execution of FHE computations across diverse hardware platforms:

Tensor-based Design: The core operations and composite operations are typically specified in terms of tensors, enabling them to leverage the inherent parallelism of modern hardware accelerators. This design ensures the non-sequential nature of FHE workflows is decoupled from hardware-specific parallelism constraints, allowing algorithms to express computational requirements independently of underlying hardware architecture. In some embodiments, up to four-dimensional (4D) tensors are supported. In other embodiments, higher dimensionality can be supported as well.

Standardized Data Representation: FHE computations often involve mathematical operations over polynomials that are represented as multi-dimensional structures, with one axis corresponding to the polynomial degree (number of coefficients, m) and another axis to multiple modulus values (k). HEAL 48 standardizes the representation across the various core operations, in order to reduce data reordering overhead. Typically, the core operations have a standard input format, e.g., they expect k modulo values on the rightmost axis, and align input dimensions accordingly.

Versatile Modular Arithmetic: The core operations provide comprehensive modular arithmetic capabilities including operations between polynomials and operations between a polynomial and a constant, such as Number Theoretic Transform (NTT), its inverse (INTT) and coefficient permutation. These operations form the computational building blocks of most FHE schemes and are optimized for parallel execution on hardware accelerators.

Specialized Computation Pipelines: In some embodiments, the core and/or composite operations include functions specifically designed for common FHE tasks, such as modulus-switch, key-switch, gadget decomposition and bootstrapping, ensuring efficient integration with hardware capable of performing these operations at the chip level. These specialized pipelines eliminate the need for generic computational approaches that may not fully exploit FHE-specific optimization opportunities.

Data Type Flexibility: HEAL 48 supports multiple data types, such as int32 and int64, facilitating compatibility with hardware and software optimized for various precision levels. This flexibility enables deployment across different hardware platforms with varying computational capabilities and precision requirements.

Efficient Memory and Data Flow Management: HEAL 48 provides sophisticated memory management capabilities between CPU 24 and hardware accelerator 28. Manual memory allocation allows developers to allocate device memory explicitly, ensuring tensors are efficiently placed in memory prior to latency-sensitive operations. Flexible reshaping operations enable data layouts to be dynamically adjusted to meet the specific requirements of FHE operations, avoiding unnecessary duplication or memory reallocation that could degrade performance.

The features listed above maximize parallelism and minimize memory and data flow bottlenecks, delivering high performance and adaptability for FHE workflows while maintaining compatibility across diverse hardware platforms.

Standardized interfaces: In some embodiments HEAL 48 provides a standardized Application Programming Interface (API), both towards CPU 24 (e.g., FHE applications 36 and algorithms 40) and towards accelerator 28. The API enables FHE developers to specify computation workflows independently of hardware constraints, and enables accelerator-software developers to optimize the implementation of core and/or composite operations independently of algorithmic issues.

Support of multiple polynomials and multiple modulo values: Some of the core operations typically support simultaneous operation on multiple polynomials and/or multiple modulus values, as applicable.

Vendor-specific optional core operations. In some embodiments, HEAL 48 enables the provider of a certain accelerator 28 to expose native or fused implementations of higher-level operations. In these embodiments, compiler 50 and runtime 54 emit the vendor-specific operations directly rather than lowering them into sequences of individual core operations. The vendor-specific operations can be viewed as optional composite operations.

Flexible computation on non-contiguous data. In the embodiments described above, HEAL core operations are defined over logical tensors whose semantics are independent of the physical layout of device memory 56. The interface between CPU 24 and accelerator 28 exposes explicit memory allocation, data transfer, and computation operations, without prescribing how allocated tensors are physically laid out within the device memory. As a result, accelerator 28 may internally represent tensors using non-contiguous or hardware-specific memory layouts, provided that the accelerator maintains the required mapping between logical tensor elements and physical memory locations. Core operations are implemented by the accelerator in accordance with this internal mapping, allowing computations to be performed correctly over non-contiguous memory without requiring explicit reordering, strided access specifications, or indexing instructions from CPU 24. This decoupling enables hardware implementations to optimize memory placement and access patterns transparently, as a direct consequence of HEAL's explicit memory management and abstraction design.

### Example Heal Core Operations and Acceleration Flow

In one non-limiting example, HEAL 48 supports at least the following core operations:

TABLE 1
Example core operations

| | |
|---|---|
| modsum | Perform modular summation on |
| | vectors or scalars with varying |
| | input shapes and data types |
| modmul | Perform modular multiplication |
| | on vectors or scalars with |
| | varying input shapes and data |
| | types |
| axis_modsum | Compute modular summation along |
| | a full tensor axis |
| ntt, intt | Perform forward and inverse NTT |
| | transformations |
| permute | Reorganize tensor data based on |
| | specified indices |
| reshape | Adapt tensor dimensions for |
| | efficient compatibility between |
| | other HEAL operations |
| allocate_on_device | Allocate tensor memory in device |
| | (accelerator) memory |
| host_to_device | Transfer tensor data from CPU to |
| | device memory |
| device_to_host | Retrieve tensor data from device |
| | memory to CPU |

As noted above, in some embodiments HEAL also supports high-level FHE operations that are made of core operations. Non-limiting examples of high-level operations include the following:

TABLE 2
Example high-level FHE operations

| | |
|---|---|
| g_decomposition | Transform vector elements into digit- |
| | based representations in specified |
| | bases |
| bootstrap | Reduce accumulated ciphertext noise |
| key_switch | Convert ciphertext from one |
| | encryption key to a different |
| | encryption key |
| mod_switch | Convert the representation of a |
| | polynomial from one modulus (k) to a |
| | different modulus |

Table 2: Example high-level FHE operations

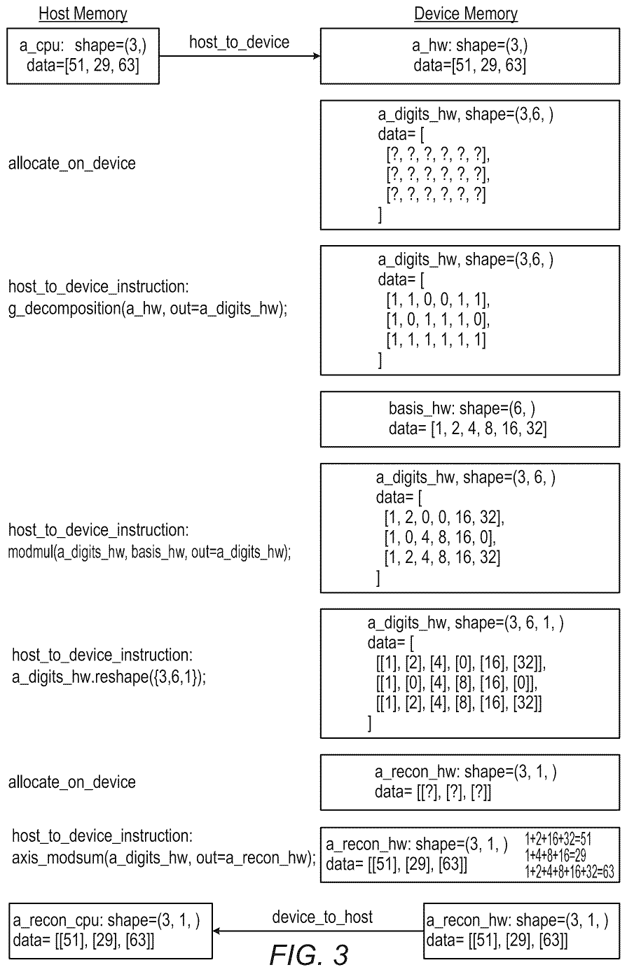

FIG. 3 is a diagram that schematically illustrates an example of accelerating an FHE computation, in accordance with an embodiment of the present invention. The example of FIG. 3 demonstrates a flow that comprises (i) decomposing a polynomial, (ii) performing modular multiplication, and (iii) reconstructing the result, using the core and composite operations of HEAL 48.

This flow simplifies a common sequence of operations in key switching, which is an essential component of many FHE schemes. The purpose of key-switching is to transform a ciphertext under one key into a ciphertext under a different key. Key switching often requires decomposition into a smaller basis to reduce noise growth during computations. The ability to decompose, operate on, and reconstruct polynomials aligns with the core requirements of key switching workflows, making this example highly relevant for practical FHE implementations. The example comprises the following steps:
Input Setup: A polynomial (a_cpu) is defined, along with its parameters: degree, base_bits, and a basis vector.
Move Data to Hardware: The input polynomial and basis vector are transferred to device memory using host_to_device.
Decomposition: The g_decomposition function splits the polynomial into its digit-based representation based on the specified base_bits.
Memory Allocation: Device memory is allocated for intermediate results using allocate_on_device.
Modular Multiplication: The decomposed polynomial is multiplied by the basis vector using modmul, saving the result in-place in the same device memory location as the decomposed polynomial.
Reshaping: The multiplication result is reshaped to match the input requirements of axis modsum.
Axis-wise Summation: The axis modsum function performs modular summation along the tensor axis to reconstruct the polynomial.
Move Data to CPU: The reconstructed polynomial is retrieved from hardware memory using device_to_host.

Actual program code of some of the core operations of Table 1, and code that implements the example flow of FIG. 3, are given in U.S. Provisional Patent Application 63/752,866, cited above.

### Additional Embodiments and Variations

### Manual Memory Level Allocation

In some embodiments, the core operations of HEAL 48 provide support for manual memory level (e.g., cache level) allocation. Such core operations enable FHE algorithm designers to specify which data should be stored in specific memory levels of device memory 56. For example, the core operations may allow placement of frequently accessed data in low-latency memory tiers for performance-critical tasks. Less frequently accessed data can be specified to be stored in higher-capacity but slower memory levels. Typically, these core operations do not require the FHE algorithm designer to be aware of the actual memory-level structure of device memory 56.

### Runtime Performance Profiling

In some embodiments, HEAL 48 provides support for runtime profiling. Runtime performance profiling is important for identifying bottlenecks and optimizing FHE workflows on specific accelerators. By integrating profiling tools into HEAL 48, designers may measure actual latency, throughput and memory usage for each core operation. This sort of profiling provides detailed insights into hardware utilization, including accelerator occupancy and memory bandwidth.

Runtime profiling also enables developers to trace execution workflows and identify suboptimal configurations. Developers can leverage profiling tools to fine-tune data layouts, kernel launches, and memory placements, maximizing hardware efficiency of accelerator 28. In some embodiments, profiling support can be provided as a lightweight, optional module in HEAL 48 that integrates seamlessly with the core operations and generates reports in standard formats for analysis.

Although the embodiments described herein mainly address homomorphic encryption, the methods and systems described herein can also be used in other applications of lattice-based cryptography, such as in post-quantum encryption and signature systems, private information retrieval, multiparty computation and zero-knowledge proofs.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus for performing Fully Homomorphic Encryption (FHE) computations, the apparatus comprising:
an accelerator interface, configured to communicate with a hardware accelerator; and
a processor, configured to:
receive or generate an accelerator-agnostic workflow that comprises one or more FHE computations;
compile the accelerator-agnostic workflow into a transcript of operations drawn from a predefined set of operations in which (i) data is represented using tensors and (ii) at least some of the operations are represented as parallelized computations over dimensions of the tensors; and
send the transcript for execution on the hardware accelerator.

2. The apparatus according to claim 1, wherein compilation of the accelerator-agnostic workflow, and the transcript produced by the compilation, are specific to a type of the accelerator.

3. The apparatus according to claim 1, wherein at least some of the operations in the set represent data as polynomials represented in a double Chinese Remainder Theorem (CRT) format, and represent the polynomials using respective tensors.

4. The apparatus according to claim 3, wherein one or more of the operations in the set comprises an operation between tensors that represent the polynomials.

5. The apparatus according to claim 3, wherein one or more of the operations in the set comprise an operation between a tensor representing a polynomial and a constant.

6. The apparatus according to claim 1, wherein the set of operations comprises an operation that applies a Number Theoretic Transform (NTT) or an inverse NTT to a polynomial represented as a tensor.

7. The apparatus according to claim 1, wherein the set of operations comprises one or both of:
an operation that permutes coefficients of a vector; and
an operation that reshapes a tensor.

8. The apparatus according to claim 1, wherein, in compiling the accelerator-agnostic workflow, the CPU is configured to use one or more predefined composite FHE operations, a given composite FHE operation made up of two or more of the operations in the set.

9. The apparatus according to claim 8, wherein the composite FHE operations comprise one or more of:
an operation that decomposes a polynomial into a digit-based representation;
an operation that converts ciphertext from a first encryption key to a second encryption key;
an operation that performs bootstrapping; and
an operation that converts a representation of a polynomial from a first modulus to a second modulus.

10. A method for performing Fully Homomorphic Encryption (FHE) computations, the method comprising:
receiving an accelerator-agnostic workflow that comprises one or more FHE computations;
compiling the accelerator-agnostic workflow into a transcript of operations drawn from a predefined set of operations in which (i) data is represented using tensors and (ii) at least some of the operations are represented as parallelized computations over dimensions of the tensors; and
send the transcript for execution on a hardware accelerator.

11. The method according to claim 10, wherein compilation of the accelerator-agnostic workflow, and the transcript produced by the compilation, are specific to a type of the accelerator.

12. The method according to claim 10, wherein at least some of the operations in the set represent data as polynomials represented in a double Chinese Remainder Theorem (CRT) format, and represent the polynomials using respective tensors.

13. The method according to claim 12, wherein one or more of the operations in the set comprises an operation between tensors that represent the polynomials.

14. The method according to claim 12, wherein one or more of the operations in the set comprises an operation between a tensor representing a polynomial and a constant.

15. The method according to claim 10, wherein the set of operations comprises an operation that applies a Number Theoretic Transform (NTT) or an inverse NTT to a polynomial represented as a tensor.

16. The method according to claim 10, wherein the set of operations comprises one or both of:
an operation that permutes coefficients of a vector; and
an operation that reshapes a tensor.

17. The method according to claim 10, wherein, in compiling the accelerator-agnostic workflow, the CPU is configured to use one or more predefined composite FHE operations, a given composite FHE operation made up of two or more of the operations in the set.

18. The method according to claim 17, wherein the composite FHE operations comprise one or more of:
an operation that decomposes a polynomial into a digit-based representation;
an operation that converts ciphertext from a first encryption key to a second encryption key;
an operation that performs bootstrapping; and
an operation that converts a representation of a polynomial from a first modulus to a second modulus.

19. A computer software product, the product comprising a tangible non-transitory computer-readable medium in which program instructions are stored, which instructions, when read by one or more processors, cause the one or more processors to:
receive or generate an accelerator-agnostic workflow that comprises one or more Fully Homomorphic Encryption (FHE) computations;
compile the accelerator-agnostic workflow into a transcript of operations drawn from a predefined set of operations in which (i) data is represented using tensors and (ii) at least some of the operations are represented as parallelized computations over dimensions of the tensors; and
send the transcript for execution on a hardware accelerator.
